(19) United States
(12) Patent Application Publication
(10) Pub. No.: US 2015/0092683 A1
(43) Pub. Date: Apr. 2, 2015

(54) DYNAMIC SECONDARY CELL (SCELL) ALLOCATION AND FREQUENCY PLANNING FOR CARRIER AGGREGATION

(71) Applicant: QUALCOMM Incorporated, San Diego, CA (US)

(72) Inventors: Rajagopalan RANGARAJAN, San Diego, CA (US); Pushp Kumar TRIKHA, San Diego, CA (US); Chiewcharn NARATHONG, Laguna Niguel, CA (US)

(21) Appl. No.: 14/310,590

(22) Filed: Jun. 20, 2014

Related U.S. Application Data
(60) Provisional application No. 61/883,557, filed on Sep. 27, 2013.

(51) Int. Cl. H04W 48/18

(52) U.S. Cl. CPC H04W 48/18
USPC 370/329

(57) ABSTRACT

Certain aspects of the present disclosure provide methods and apparatus for dynamically secondary cell (SCELL) allocation and frequency planning for carrier aggregation. One example system for radio frequency (RF) signal processing, generally includes a first integrated circuit (IC) comprising two or more receive chains, each receive chain for processing one of multiple component carriers in a carrier aggregation (CA) signal, wherein the first IC is configured to downconvert a signal associated with a primary cell of the CA signal; and a second IC configured to downconvert one or more signals associated with one or more secondary cells of the CA signal. The second IC may also be configured to upconvert a signal having a frequency different than the primary cell by an offset associated with the primary cell.

### CLAIM OF PRIORITY UNDER 35 U.S.C. §119

This application claims benefit of U.S. Provisional Patent Application Ser. No. 61/883,557, filed Sep. 27, 2013 and entitled “Dynamic Secondary Cell (SCELL) Allocation and Frequency Planning for Carrier Aggregation,” which is herein incorporated by reference in its entirety.

### TECHNICAL FIELD

Certain aspects of the present disclosure generally relate to wireless communications and, more particularly, to dynamic secondary cell (SCELL) allocation and frequency planning for carrier aggregation (CA) in radio frequency front ends (RFFEs).

### BACKGROUND

Wireless communication networks are widely deployed to provide various communication services such as telephony, video, data, messaging, broadcasts, and so on. Such networks, which are usually multiple access networks, support communications for multiple users by sharing the available network resources. For example, one network may be a 3G (the third generation of mobile phone standards and technology) system, which may provide network service via any one of various 3G radio access technologies (RATs) including EVDO (Evolution-Data Optimized), 1xRTT (1 times Radio Transmission Technology, or simply 1x), W-CDMA (Wideband Code Division Multiple Access), UMTS-TDD (Universal Mobile Telecommunications System-Time Division Duplexing), HSPA (High Speed Packet Access), GPRS (General Packet Radio Service), or EDGE (Enhanced Data rates for Global Evolution). The 3G network is a wide area cellular telephone network that evolved to incorporate high-speed internet access and video telephony, in addition to voice calls. Furthermore, a 3G network may be more established and provide larger coverage areas than other network systems. Such multiple access networks may also include code division multiple access (CDMA) systems, time division multiple access (TDMA) systems, frequency division multiple access (FDMA) systems, orthogonal frequency division multiple access (OFDMA) systems, single-carrier FDMA (SC-FDMA) networks, 3^{rd} Generation Partnership Project (3GPP) Long Term Evolution (LTE) networks, and Long Term Evolution Advanced (LTE-A) networks.

A wireless communication network may include a number of base stations that can support communication for a number of mobile stations. A mobile station (MS) may communicate with a base station (BS) via a downlink and an uplink. The downlink (or forward link) refers to the communication link from the base station to the mobile station, and the uplink (or reverse link) refers to the communication link from the mobile station to the base station. A base station may transmit data and control information on the downlink to a mobile station and/or may receive data and control information on the uplink from the mobile station.

### SUMMARY

Certain aspects of the present disclosure generally relate to dynamic secondary cell (SCELL) allocation and frequency planning for carrier aggregation (CA). Certain aspects of the present disclosure can significantly reduce coupling issues in carrier aggregation cases and avoid degradation in sensitivity.

Certain aspects of the present disclosure provide a system for radio frequency (RF) signal processing, which may be used for wireless communications, for example. The system generally includes a first integrated circuit (IC) having at least portions of two or more receive chains, each receive chain for processing one of multiple component carriers in a CA signal, wherein the first IC is configured to downconvert a signal associated with a primary cell (PCELL) of the CA signal; and a second IC configured to downconvert one or more signals associated with one or more secondary cells (SCELLs) of the CA signal.

According to certain aspects, the second IC may also be configured to upconvert a transmit signal having a frequency different than the primary cell by an offset (e.g., a duplex offset, which is also known as duplex spacing) associated with the primary cell. As used herein, this frequency offset generally refers to the difference between uplink (UL) and (DL) subbands in frequency-division duplex (FDD) mode for a given component carrier (CC).

According to certain aspects, the first IC is a CA receiver (RX CA). For certain aspects, the second IC is a transceiver (TX/RX). For other aspects, the first IC is a transceiver, and the second IC is a CA receiver.

According to certain aspects, the first IC includes a first low noise amplifier (LNA) configured to amplify a signal associated with a first one of the secondary cells of the CA signal, and the second IC is configured to receive and to downconvert the amplified signal associated with the first one of the secondary cells. For certain aspects, the first IC includes a second LNA configured to amplify the signal associated with the primary cell of the CA signal, and the first IC is configured to downconvert the amplified signal associated with the primary cell. For certain aspects, the first IC includes a second LNA configured to amplify another signal associated with a second one of the secondary cells of the CA signal, and the second IC is configured to receive and to downconvert the other amplified signal associated with the second one of the secondary cells. For other aspects, the second IC includes a second LNA configured to amplify another signal associated with a second one of the secondary cells of the CA signal, and the second IC is configured to downconvert the other amplified signal associated with the second one of the secondary cells.

According to certain aspects, the primary cell is in Evolved UMTS (Universal Mobile Telecommunications System) Terrestrial Radio Access (E-UTRA) frequency band 4 (B4), and at least one of the secondary cells is in E-UTRA frequency band 2 (B2). For other aspects, the primary cell and at least one of the secondary cells are in the same E-UTRA frequency band.

According to certain aspects, the first IC includes a first voltage controlled oscillator (VCO) configured to generate a first local oscillating signal for mixing with the signal associated with the primary cell. For certain aspects, the second IC includes a second VCO configured to generate a second local oscillating signal for mixing with a signal associated with a secondary cell of the CA signal. The second IC may also include a third VCO configured to generate a third local oscillating signal for mixing with the transmit signal.

According to certain aspects, the circuit further includes an antenna configured to receive the CA signal and at least one of a duplexer, a diplexer, a triplexer, or a quadplexer configured to filter the CA signal into the multiple component carriers for processing in the two or more receive chains. For certain aspects, the circuit also includes a power amplifier for amplifying the upconverted transmit signal. The amplified upconverted transmit signal may be sent to the antenna via the at least one of the duplexer, the diplexer, the triplexer, or the quadplexer for wireless transmission.

Certain aspects of the present disclosure provide a system for RF signal processing, which may be used for wireless communications, for example. The system typically includes a first IC and a second IC. The first IC generally includes at least portions of two or more receive chains, each receive chain for processing one of multiple component carriers in a CA signal; a first VCO for producing a first VCO signal; and a first frequency dividing circuit selectively configurable to frequency divide the first VCO signal by at least one of 2, 3, and 4 to generate a first local oscillating signal for downconverting a signal associated with a first component carrier of the CA signal. The second IC generally includes a second VCO for producing a second VCO signal; a second frequency dividing circuit selectively configurable to frequency divide the second VCO signal by at least one of 2 and 4 to generate a second local oscillating signal for downconverting a signal associated with a second component carrier of the CA signal; a third VCO for producing a third VCO signal; and a third frequency dividing circuit selectively configurable to frequency divide the third VCO signal by at least one of 2, 3, and 4 to generate a third local oscillating signal for upconverting a transmit signal having a frequency different than a first one of the multiple component carriers by an offset associated with the first one of the multiple component carriers.

According to certain aspects, the first IC is a CA receiver (RX CA). For certain aspects, the second IC is a transceiver (TX/RX).

According to certain aspects, the second frequency dividing circuit is selectively configurable to frequency divide the second VCO signal by 2, by 3, and by 4.

According to certain aspects, at least one of the first or the second frequency dividing circuit is selectively configurable to frequency divide the first or the second VCO signal, respectively, by 2, by 3, by 4, and by 6.

According to certain aspects, the first IC includes a first LNA configured to amplify a second one of the multiple component carriers to generate the signal associated with the second component carrier of the CA signal. The second IC may be configured to receive the signal associated with the second component carrier from the first IC before downconverting. For certain aspects, the first IC includes a second LNA configured to amplify a third one of the multiple component carriers to generate the signal associated with the first component carrier of the CA signal before downconverting. The third one of the multiple component carriers may be the same as the first one of the multiple component carriers. For certain aspects, the first IC includes a second LNA configured to amplify a third one of the multiple component carriers. In this case, the second IC may be configured to receive and to downconvert the amplified third one of the multiple component carriers. For certain aspects, the second IC includes a second LNA configured to amplify a third one of the multiple component carriers. In this case, the second IC may be configured to downconvert the amplified third one of the multiple component carriers.

According to certain aspects, the circuit further includes an antenna configured to receive the CA signal and at least one of a duplexer, a diplexer, a triplexer, or a quadplexer configured to filter the CA signal into the multiple component carriers for processing in the two or more receive chains. For certain aspects, the circuit also includes a power amplifier for amplifying the upconverted signal. The amplified upconverted signal may be sent to the antenna via the at least one of the duplexer, the diplexer, the triplexer, or the quadplexer for transmission.

According to certain aspects, the first one of the multiple component carriers may be the first component carrier of the CA signal. The first one of the multiple component carriers may be the PCELL, and the second one of the multiple component carriers may be an SCELL.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram of an example wireless communications network in accordance with certain aspects of the present disclosure.

FIG. 2 is a block diagram of an example access point (AP) and example user terminals in accordance with certain aspects of the present disclosure.

FIG. 3 is a block diagram of an example transceiver front end in accordance with certain aspects of the present disclosure.

FIG. 4A is an example block diagram of a receiver carrier aggregation (RX CA) integrated circuit (IC) for one downlink (DL) channel and a transceiver (TX/RX) IC for one DL channel and one uplink (UL) channel (i.e., a 1DL1UL+1DL case), where the primary cell (PCELL) is allocated to downconvert on the TX/RX IC, in accordance with certain aspects of the present disclosure.

FIG. 4B is an example block diagram of the RX CA IC and the TX/RX IC of FIG. 4A, where the PCELL is allocated to downconvert on the RX CA IC, in accordance with certain aspects of the present disclosure.

FIG. 5A is an example block diagram of an RX CA IC for one DL channel and a TX/RX IC for two DL channels and one UL channel (i.e., a 2DL1UL+1DL case), where the PCELL is allocated to downconvert on the TX/RX IC, in accordance with certain aspects of the present disclosure.

FIG. 5B is an example block diagram of the RX CA IC and the TX/RX IC of FIG. 5A, where the PCELL is allocated to downconvert on the RX CA IC, in accordance with certain aspects of the present disclosure.

FIG. 6A is an example block diagram of an RX CA IC for one DL channel and a TX/RX IC for three DL channels and one UL channel (i.e., a 3DL1UL+1DL case), where the PCELL is allocated to downconvert on the TX/RX IC, in accordance with certain aspects of the present disclosure.

FIG. 6B is an example block diagram of the RX CA IC and the TX/RX IC of FIG. 6A, where the PCELL is allocated to downconvert on the RX CA IC, in accordance with certain aspects of the present disclosure.

FIG. 7 is a flow diagram of example operations for dynamic SCELL allocation, in accordance with certain aspects of the present disclosure.

FIG. 8A is an example block diagram of an RX CA IC for one DL channel and a TX/RX IC for two DL channels and one UL channel (i.e., a 2DL1UL+1DL case), where the RX CA IC employs a divide-by-2 frequency dividing circuit, in accordance with certain aspects of the present disclosure.

FIG. 8B is an example block diagram of the RX CA IC for one DL channel and the TX/RX IC for two DL channels and one UL channel of FIG. 8A, where the RX CA IC employs a divide-by-3 frequency dividing circuit according to a designed frequency plan, in accordance with certain aspects of the present disclosure.

FIG. 9A is an example block diagram of an RX CA IC for one DL channel and a TX/RX IC for two DL channels and two UL channels (i.e., a 2DL2UL+1DL case), where the RX CA IC employs a divide-by-2 frequency dividing circuit, in accordance with certain aspects of the present disclosure.

FIG. 9B is an example block diagram of the RX CA IC for one DL channel and the TX/RX IC for two DL channels and two UL channels of FIG. 9A, where the RX CA IC employs a divide-by-3 frequency dividing circuit according to a designed frequency plan, in accordance with certain aspects of the present disclosure.

### DETAILED DESCRIPTION

Various aspects of the present disclosure are described below. It should be apparent that the teachings herein may be embodied in a wide variety of forms and that any specific structure, function, or both being disclosed herein is merely representative. Based on the teachings herein, one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

The word “exemplary” is used herein to mean “serving as an example, instance, or illustration.” Any aspect described herein as “exemplary” is not necessarily to be construed as preferred or advantageous over other aspects.

The techniques described herein may be used in combination with various wireless technologies such as Code Division Multiple Access (CDMA), Orthogonal Frequency Division Multiplexing (OFDM), Time Division Multiple Access (TDMA), Spatial Division Multiple Access (SDMA), Single Carrier Frequency Division Multiple Access (SC-FDMA), Time Division Synchronous Code Division Multiple Access (TD-SCDMA), and so on. Multiple user terminals can concurrently transmit/receive data via different (1) orthogonal code channels for CDMA, (2) time slots for TDMA, or (3) sub-bands for OFDM. A CDMA system may implement IS-2000, IS-95, IS-856, Wideband-CDMA (W-CDMA), or some other standards. An OFDM system may implement Institute of Electrical and Electronics Engineers (IEEE) 802.11, IEEE 802.16, Long Term Evolution (LTE) (e.g., in TDD and/or FDD modes), or some other standards. A TDMA system may implement Global System for Mobile Communications (GSM) or some other standards. These various standards are known in the art.

### An Example Wireless System

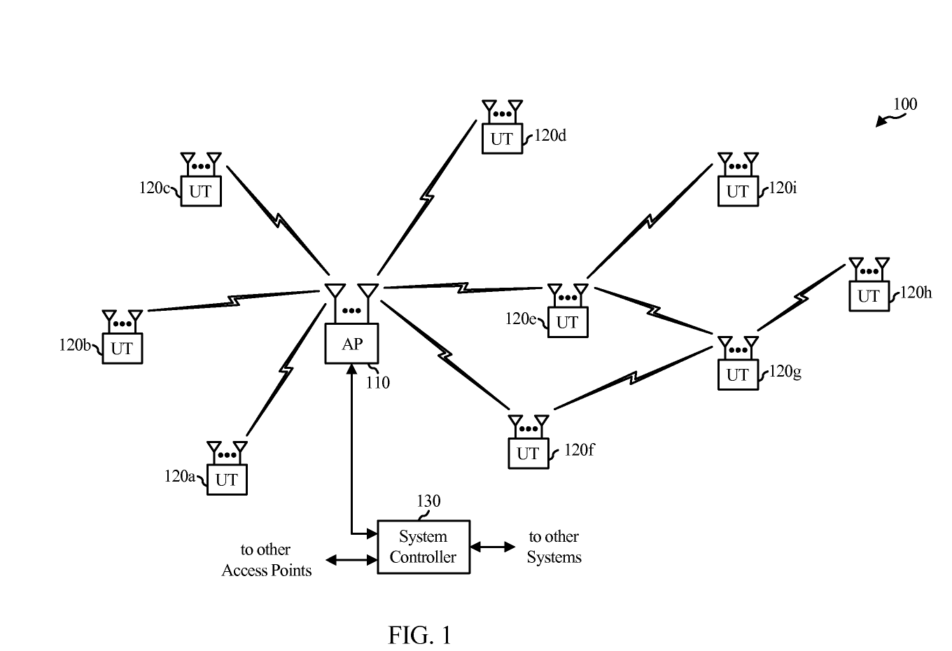

FIG. 1 illustrates a wireless communications system 100 with access points and user terminals. For simplicity, only one access point 110 is shown in FIG. 1. An access point (AP) is generally a fixed station that communicates with the user terminals and may also be referred to as a base station (BS), an evolved Node B (eNB), or some other terminology. A user terminal (UT) may be fixed or mobile and may also be referred to as a mobile station (MS), an access terminal, user equipment (UE), a station (STA), a client, a wireless device, or some other terminology. A user terminal may be a wireless device, such as a cellular phone, a personal digital assistant (PDA), a handheld device, a wireless modem, a laptop computer, a tablet, a personal computer, etc.

Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

System 100 employs multiple transmit and multiple receive antennas for data transmission on the downlink and uplink. Access point 110 may be equipped with a number Nₐₚ of antennas to achieve transmit diversity for downlink transmissions and/or receive diversity for uplink transmissions. A set Nᵤ of selected user terminals 120 may receive downlink transmissions and transmit uplink transmissions. Each selected user terminal transmits user-specific data to and/or receives user-specific data from the access point. In general, each selected user terminal may be equipped with one or multiple antennas (i.e., Nᵤₜ≧1). The Nᵤ selected user terminals can have the same or different number of antennas.

Wireless system 100 may be a time division duplex (TDD) system or a frequency division duplex (FDD) system. For a TDD system, the downlink and uplink share the same frequency band. For an FDD system, the downlink and uplink use different frequency bands. System 100 may also utilize a single carrier or multiple carriers for transmission. Each user terminal may be equipped with a single antenna (e.g., in order to keep costs down) or multiple antennas (e.g., where the additional cost can be supported).

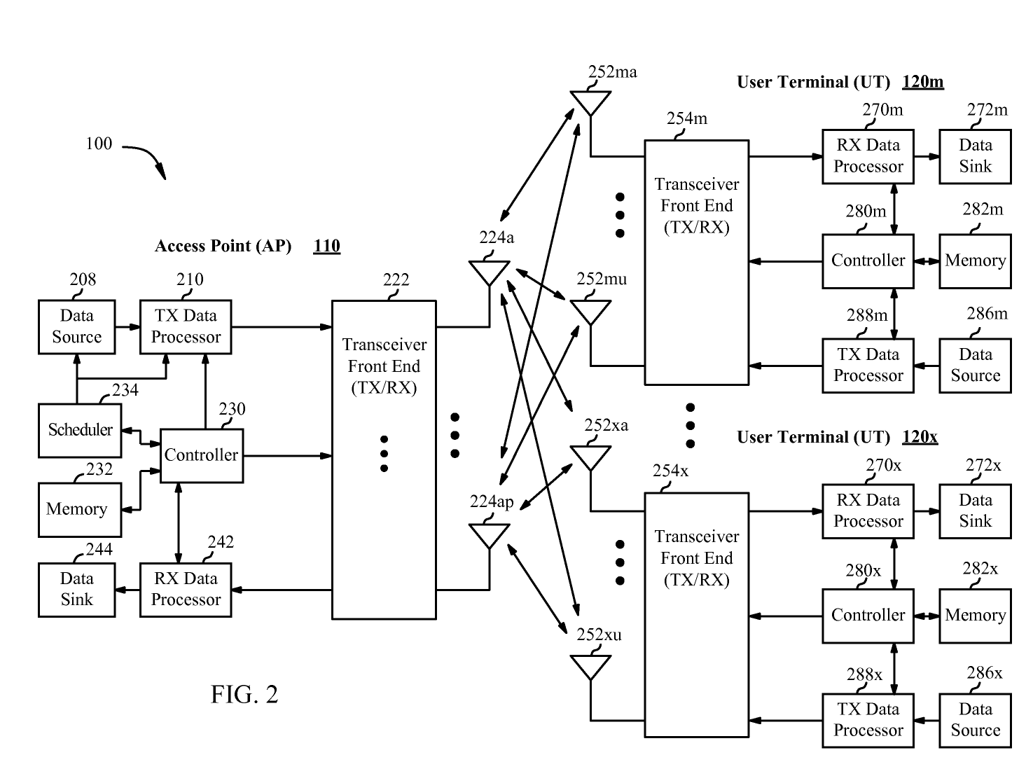

FIG. 2 shows a block diagram of access point 110 and two user terminals 120m and 120x in wireless system 100. Access point 110 is equipped with Nₐₚ antennas 224a through 224ap. User terminal 120m is equipped with N_{ut,m} antennas 252ma through 252mu, and user terminal 120x is equipped with N_{ut,x} antennas 252xa through 252xu. Access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a frequency channel, and a “receiving entity” is an independently operated apparatus or device capable of receiving data via a frequency channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. Beam-steering or some other spatial processing technique may be used at the access point and user terminal.

On the uplink, at each user terminal 120 selected for uplink transmission, a TX data processor 288 receives traffic data from a data source 286 and control data from a controller 280. TX data processor 288 processes (e.g., encodes, interleaves, and modulates) the traffic data {dᵤₚ} for the user terminal based on the coding and modulation schemes associated with the rate selected for the user terminal and provides a data symbol stream {sᵤₚ} for one of the N_{ut,m} antennas. A transceiver front end (TX/RX) 254 (also known as a radio frequency front end (RFFE)) receives and processes (e.g., converts to analog, amplifies, filters, and frequency upconverts) a respective symbol stream to generate an uplink signal. The transceiver front end 254 may also route the uplink signal to one of the N_{ut,m} antennas for transmit diversity via an RF switch, for example. The controller 280 may control the routing within the transceiver front end 254. Memory 282 may store data and program codes for the user terminal 120 and may interface with the controller 280.

A number Nᵤₚ of user terminals may be scheduled for simultaneous transmission on the uplink. Each of these user terminals transmits its set of processed symbol streams on the uplink to the access point.

At access point 110, Nₐₚ antennas 224a through 224ap receive the uplink signals from all Nᵤₚ user terminals transmitting on the uplink. For receive diversity, a transceiver front end 222 may select signals received from one of the antennas 224 for processing. For certain aspects of the present disclosure, a combination of the signals received from multiple antennas 224 may be combined for enhanced receive diversity. The access point's transceiver front end 222 also performs processing complementary to that performed by the user terminal's transceiver front end 254 and provides a recovered uplink data symbol stream. The recovered uplink data symbol stream is an estimate of a data symbol stream {sᵤₚ} transmitted by a user terminal An RX data processor 242 processes (e.g., demodulates, deinterleaves, and decodes) the recovered uplink data symbol stream in accordance with the rate used for that stream to obtain decoded data. The decoded data for each user terminal may be provided to a data sink 244 for storage and/or a controller 230 for further processing.

On the downlink, at access point 110, a TX data processor 210 receives traffic data from a data source 208 for N_{dn} user terminals scheduled for downlink transmission, control data from a controller 230 and possibly other data from a scheduler 234. The various types of data may be sent on different transport channels. TX data processor 210 processes (e.g., encodes, interleaves, and modulates) the traffic data for each user terminal based on the rate selected for that user terminal TX data processor 210 may provide a downlink data symbol streams for one of more of the N_{dn} user terminals to be transmitted from one of the Nₐₚ antennas. The transceiver front end 222 receives and processes (e.g., converts to analog, amplifies, filters, and frequency upconverts) the symbol stream to generate a downlink signal. The transceiver front end 222 may also route the downlink signal to one or more of the Nₐₚ antennas 224 for transmit diversity via an RF switch, for example. The controller 230 may control the routing within the transceiver front end 222. Memory 232 may store data and program codes for the access point 110 and may interface with the controller 230.

At each user terminal 120, N_{ut,m} antennas 252 receive the downlink signals from access point 110. For receive diversity at the user terminal 120, the transceiver front end 254 may select signals received from one of the antennas 252 for processing. For certain aspects of the present disclosure, a combination of the signals received from multiple antennas 252 may be combined for enhanced receive diversity. The user terminal's transceiver front end 254 also performs processing complementary to that performed by the access point's transceiver front end 222 and provides a recovered downlink data symbol stream. An RX data processor 270 processes (e.g., demodulates, deinterleaves, and decodes) the recovered downlink data symbol stream to obtain decoded data for the user terminal.

Those skilled in the art will recognize the techniques described herein may be generally applied in systems utilizing any type of multiple access schemes, such as TDMA, SDMA, Orthogonal Frequency Division Multiple Access (OFDMA), CDMA, SC-FDMA, TD-SCDMA, and combinations thereof

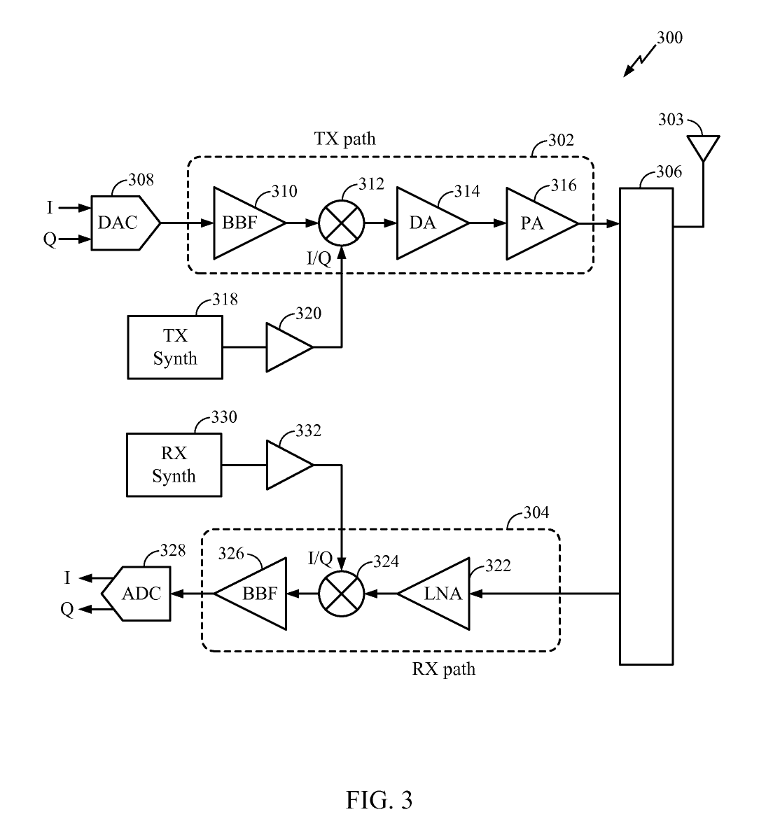

FIG. 3 is a block diagram of an example transceiver front end 300, such as transceiver front ends 222, 254 in FIG. 2, in accordance with certain aspects of the present disclosure. The transceiver front end 300 includes a transmit (TX) path 302 (also known as a transmit chain) for transmitting signals via one or more antennas and a receive (RX) path 304 (also known as a receive chain) for receiving signals via the antennas. When the TX path 302 and the RX path 304 share an antenna 303, the paths may be connected with the antenna via an interface 306, which may include any of various suitable RF devices, such as a duplexer, a switch, a diplexer, and the like.

Receiving in-phase (I) or quadrature (Q) baseband analog signals from a digital-to-analog converter (DAC) 308, the TX path 302 may include a baseband filter (BBF) 310, a mixer 312, a driver amplifier (DA) 314, and a power amplifier 316. The BBF 310, the mixer 312, and the DA 314 may be included in a radio frequency integrated circuit (RFIC), while the PA 316 is often external to the RFIC. The BBF 310 filters the baseband signals received from the DAC 308, and the mixer 312 mixes the filtered baseband signals with a transmit local oscillator (LO) signal to convert the baseband signal of interest to a different frequency (e.g., upconvert from baseband to RF). This frequency conversion process produces the sum and difference frequencies of the LO frequency and the frequency of the signal of interest. The sum and difference frequencies are referred to as the beat frequencies. The beat frequencies are typically in the RF range, such that the signals output by the mixer 312 are typically RF signals, which are amplified by the DA 314 and by the PA 316 before transmission by the antenna 303.

The RX path 304 includes a low noise amplifier (LNA) 322, a mixer 324, and a baseband filter (BBF) 326. The LNA 322, the mixer 324, and the BBF 326 may be included in a radio frequency integrated circuit (RFIC), which may or may not be the same RFIC that includes the TX path components. RF signals received via the antenna 303 may be amplified by the LNA 322, and the mixer 324 mixes the amplified RF signals with a receive local oscillator (LO) signal to convert the RF signal of interest to a different baseband frequency (i.e., downconvert). The baseband signals output by the mixer 324 may be filtered by the BBF 326 before being converted by an analog-to-digital converter (ADC) 328 to digital I or Q signals for digital signal processing.

While it is desirable for the output of an LO to remain stable in frequency, tuning to different frequencies indicates using a variable-frequency oscillator, which involves compromises between stability and tunability. Contemporary systems employ frequency synthesizers with a voltage-controlled oscillator (VCO) to generate a stable, tunable LO with a particular tuning range. Thus, the transmit LO is typically produced by a TX frequency synthesizer 318, which may be buffered or amplified by amplifier 320 before being mixed with the baseband signals in the mixer 312. Similarly, the receive LO is typically produced by an RX frequency synthesizer 330, which may be buffered or amplified by amplifier 332 before being mixed with the RF signals in the mixer 324.

### Example Dynamic Scell Allocation and Frequency Planning for Carrier Aggregation

Carrier aggregation (CA) is used in some radio access technologies (RATs), such as LTE-A, in an effort to increase the bandwidth, and thereby increase bitrates. In carrier aggregation, multiple frequency resources (i.e., carriers) are allocated for sending data. Each aggregated carrier is referred to as a component carrier (CC). In LTE Rel-10, for example, up to five component carriers can be aggregated, leading to a maximum aggregated bandwidth of 100 MHz. The allocation of resources may be contiguous or non-contiguous. Non-contiguous allocation may be either intra-band (i.e., the component carriers belong to the same operating frequency band, but have one or more gaps in between) or inter-band, in which case the component carriers belong to different operating frequency bands.

A carrier aggregation transceiver may be implemented as a single integrated circuit (IC) (i.e., a single chip). However, such a transceiver may most likely suffer from multiple issues that cause de-sense and degraded performance. One issue is voltage controlled oscillator (VCO) pulling, in which two or more VCOs couple to each other and cause phase error and spurs in cases where two frequencies are close to each other (e.g., B3 RX+B8 RX, carrier aggregation of E-UTRA frequency bands 3 and 8 for DL). This may be mitigated by frequency planning for the VCO, such as using a 4 GHz VCO for a first carrier aggregation chain (CA1) and an 8 GHz VCO for a second carrier aggregation chain (CA2). Another issue involves on-chip transmit chain (TX)-to-receive chain (RX) isolation, especially TX-harmonics-to-RX isolation as in the case for B4+B17 (i.e., carrier aggregation of E-UTRA frequency bands 4 and 17) and B3+B8. This is a very difficult problem, and designers usually rely on system specification relaxation or using carriers not having the affected spectrum combinations. Yet another issue is concerned with on-chip CA1-VCO-to-CA2-LNA isolation, such as in the B2+B4 case (i.e., carrier aggregation of E-UTRA frequency bands 2 and 4). For example, 2*1970 MHz {B2 VCO frequency on B4 LNA input}−1770 MHz {B4 TX at B4 LNA input}=2170 MHz {B4 RX}. Yet another issue involves phase-locked loop (PLL) spurs no longer being limited to the duplex offset, but may most likely also include other offsets.

A few solutions have been offered to mitigate these problems. One conventional solution employs a complicated divider plan in a single-chip solution, such as WTR3925 (offered by Qualcomm, Inc. of San Diego, Calif.). This solution partially solves some of the problems presented above. Another solution put forth is using two separate ICs, typically with a standard divider plan. For example, a transceiver IC and a separate carrier aggregation receiver IC may be employed. WTR1625 (offered by Qualcomm, Inc. of San Diego, Calif.) is a standalone transceiver IC with standard div2/div4 local oscillator (LO) divider ratios (plus div6 for B20 Global Positioning Satellite (GPS) issues), and WFR1620 (offered by Qualcomm, Inc.) is a carrier aggregation receiver with standard div2/div4 LO divider ratios. Despite the use of two separate ICs, some problems still remain. The first two problems listed above disappear with separate ICs, but the last one still remains, especially for intra-band CA. For example, carrier aggregation of two component carriers in the E-UTRA frequency band 25 (B25+B25), which will come in the same LNA, where 2*1950 MHz {B25 SCELL VCO at B25 LNA input}−1910 MHz {B25 TX at B25 LNA input}=1990 MHz.

Accordingly, what is needed are techniques and apparatus for significantly reducing coupling issues in carrier aggregation cases and avoiding degradation in sensitivity.

Certain aspects of the present disclosure provide a two-IC solution with dynamic SCELL allocation. In this solution, the primary cell (PCELL) is allocated to downconvert in the same IC as the LNA port, and the secondary cell (SCELL) allocation depends on the PCELL allocation. Other aspects of the present disclosure provide one complicated-divider-plan IC with most of the DL and UL paths and another smaller IC with standard divider options plus additional divider options as desired.

### Dynamic SCELL Allocation

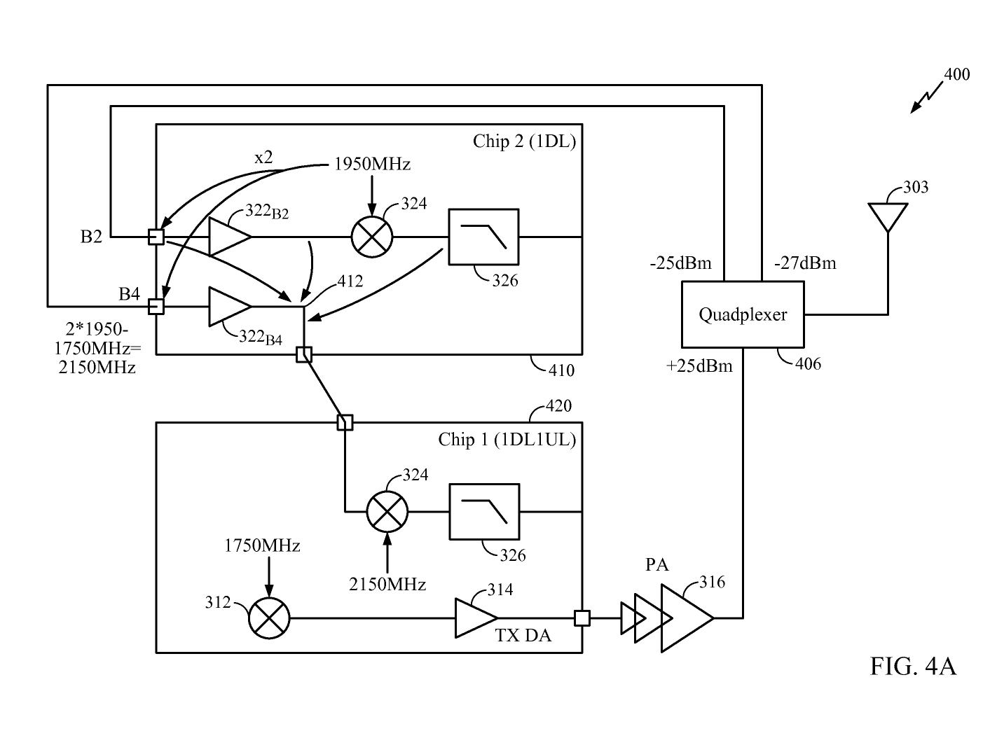

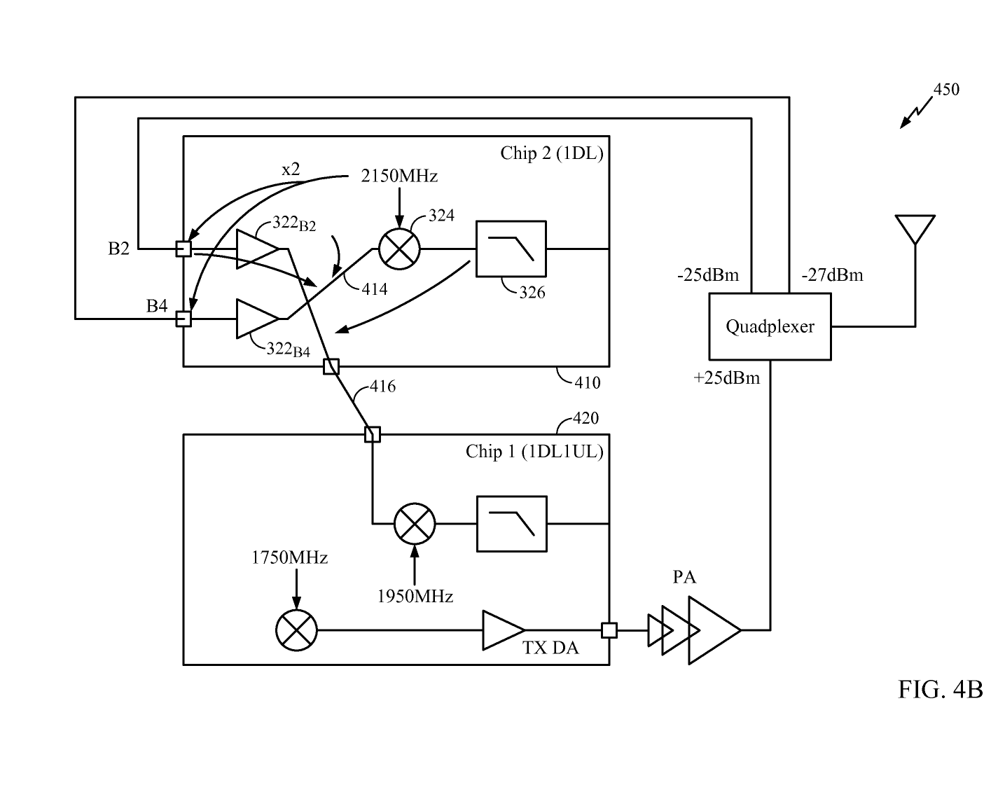

FIG. 4A illustrates an example block diagram 400 of a receiver carrier aggregation (RX CA) integrated circuit (IC) 410 for one downlink (DL) channel and a transceiver (TX/RX) IC 420 for one DL channel and one uplink (UL) channel (i.e., a 1DL1UL+1DL case), in accordance with certain aspects of the present disclosure. Here, the primary cell (PCELL) (e.g., B4) is allocated to downconvert on the TX/RX IC 420 and is also allocated to upconvert on the same IC according to the duplex offset. This leads to the SCELL VCO frequency (which is twice the SCELL LO frequency, so 2*1950 MHz for B2 RX) coupling into the PCELL RX path at a node 412, where the difference between the SCELL VCO frequency and the PCELL TX frequency (1750 MHz for B4 TX) equals the PCELL RX frequency (2150 MHz for B4 RX) and interferes with the performance of this component carrier's reception.

Starting from the B2+B4 case shown in the block diagram 400 of FIG. 4A, the PCELL (e.g., B4, or more specifically, the output of the B4 LNA 322_{B4}) is shifted to downconvert on the RX CA IC 410 (in this case, the 1DL IC) via path 414 to obtain the example block diagram 450 of FIG. 4B. Likewise, the SCELL (e.g., B2, or more specifically, the output of the B2 LNA 322_{B2}) is shifted to downconvert on the TX/RX IC 420 (in this case, the 1DL1UL IC) via path 416. In other words, the transmitter and the receiver are “dis-paired” to solve the SCELL VCO->PCELL RX coupling. This will also solve the other cases such as B25+B25 and B3+B3, which all essentially involve the same issues. In one example two-chip implementation, allocating the PCELL to downconvert on the RX CA IC 410 reduced the spur level tens of decibels (e.g., nearly 30 dB), which is a significant improvement.

Although the LNAs are shown in the RX CA IC 410 in FIG. 4B, the LNAs may reside on the TX/RX IC 420 instead for certain aspects. In this case, the PCELL is downconverted on the TX/RX IC 420, the same IC as the LNA on which the PCELL is received. For ease of description and drawings, the remainder of the present disclosure has the LNA receiving the PCELL located on the RX CA IC, but it is understood that the LNA may reside on either IC in this two-chip implementation.

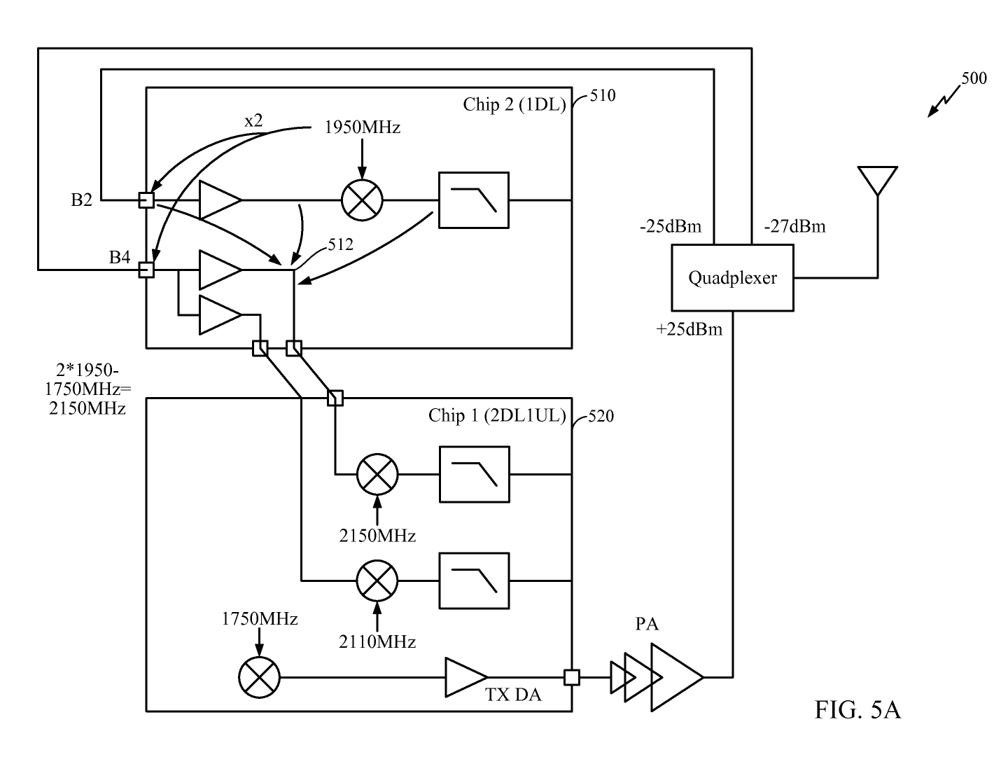

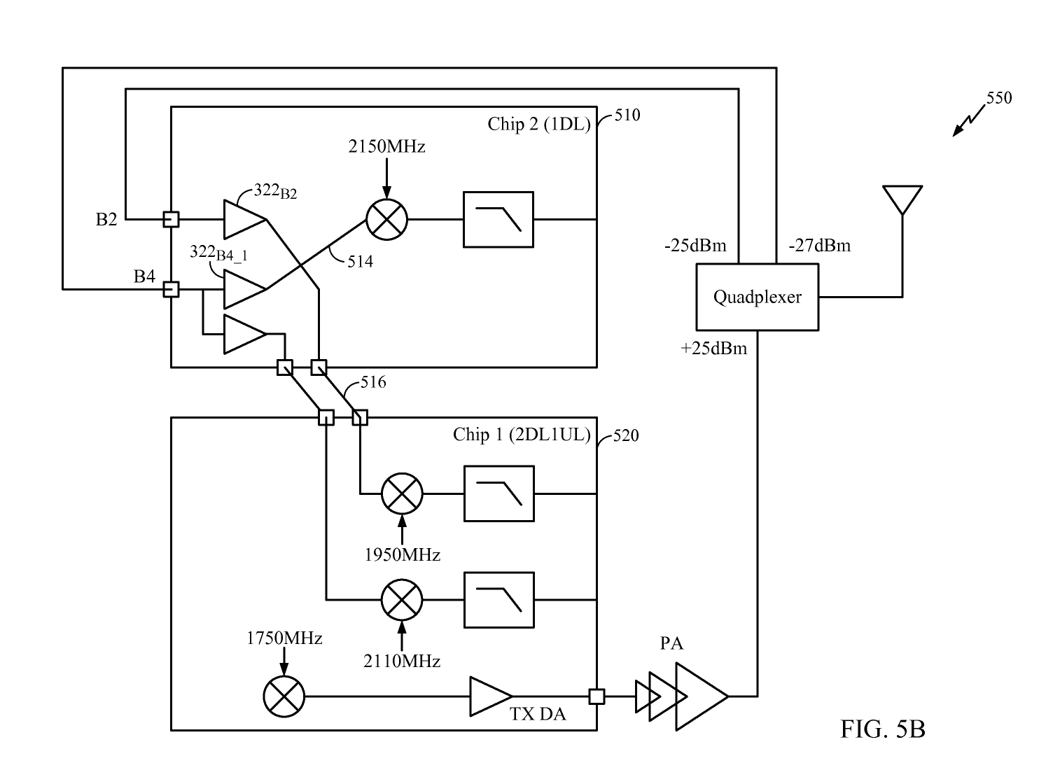

FIG. 5A illustrates an example block diagram 500 of an RX CA IC 510 for one DL channel and a TX/RX IC 520 for two DL channels and one UL channel (i.e., a 2DL1UL+1DL case). In this 3DL+1UL (e.g., B4+B4+B2) case, the PCELL (e.g., B4) is allocated to downconvert on the TX/RX IC 520 for two different carriers (e.g., 2150 MHz and 2110 MHz for B4 RX) and is also allocated to upconvert on the same IC according to the duplex offset. Similar to the block diagram 400 in FIG. 4A, this leads to the SCELL VCO frequency (which is twice the SCELL LO frequency, so 2*1950 MHz for B2 RX) coupling into the PCELL RX path at a node 512, where the difference between the SCELL VCO frequency and the PCELL TX frequency (1750 MHz for B4 TX) equals the PCELL RX frequency (2150 MHz for B4 RX) and interferes with the performance of this component carrier's reception.

FIG. 5B illustrates an example block diagram 550 of the RX CA IC 510 and the TX/RX IC 520 of FIG. 5A, where one carrier of the PCELL (e.g., B4_{—}1, or more specifically, the output 514 of the B4 LNA 322_{B4}_{_{—}}₁) is allocated to downconvert on the RX CA IC 510, in accordance with certain aspects of the present disclosure. Similar to FIG. 4B, the SCELL (e.g., B2, or more specifically, the output 516 of the B2 LNA 322_{B2}) in FIG. 5B is configured to downconvert on the TX/RX IC 520 (in this case, the 2DL1UL IC). For this B4+B4+B2 case with two ICs, the PCELL B4 downconversion occurs on the same IC (e.g., the RX CA IC 510) as the LNA 322_{B4}_{_{—}}₁ to avoid a spur problem.

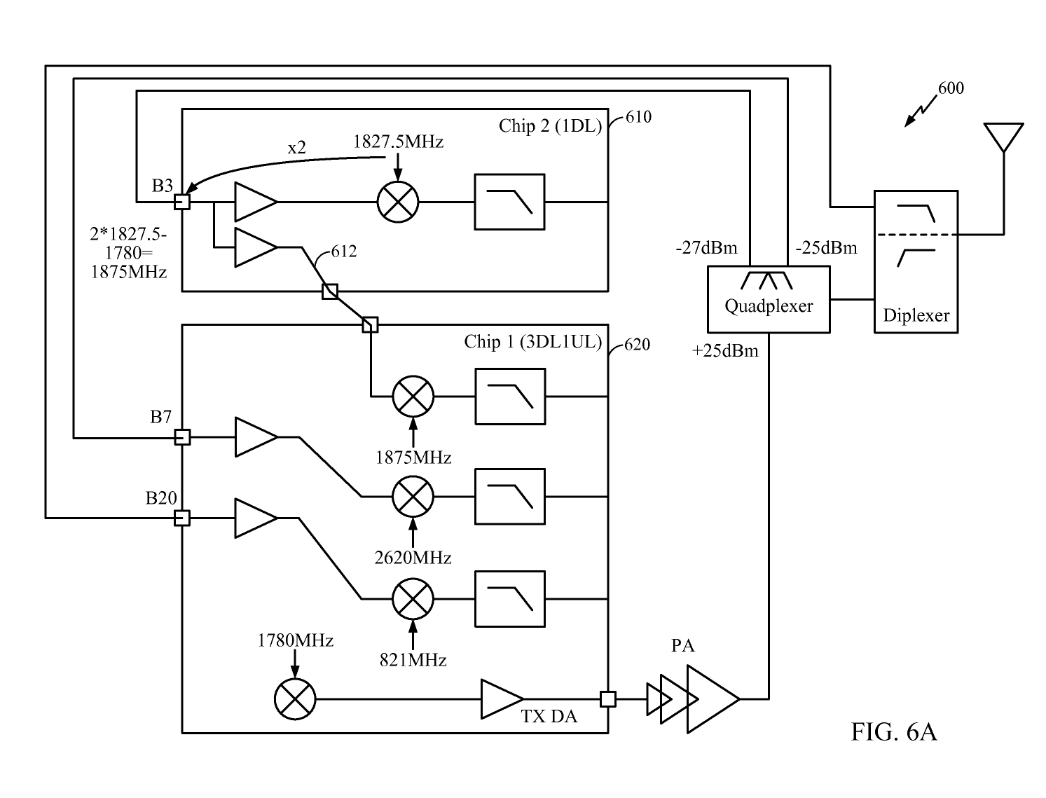

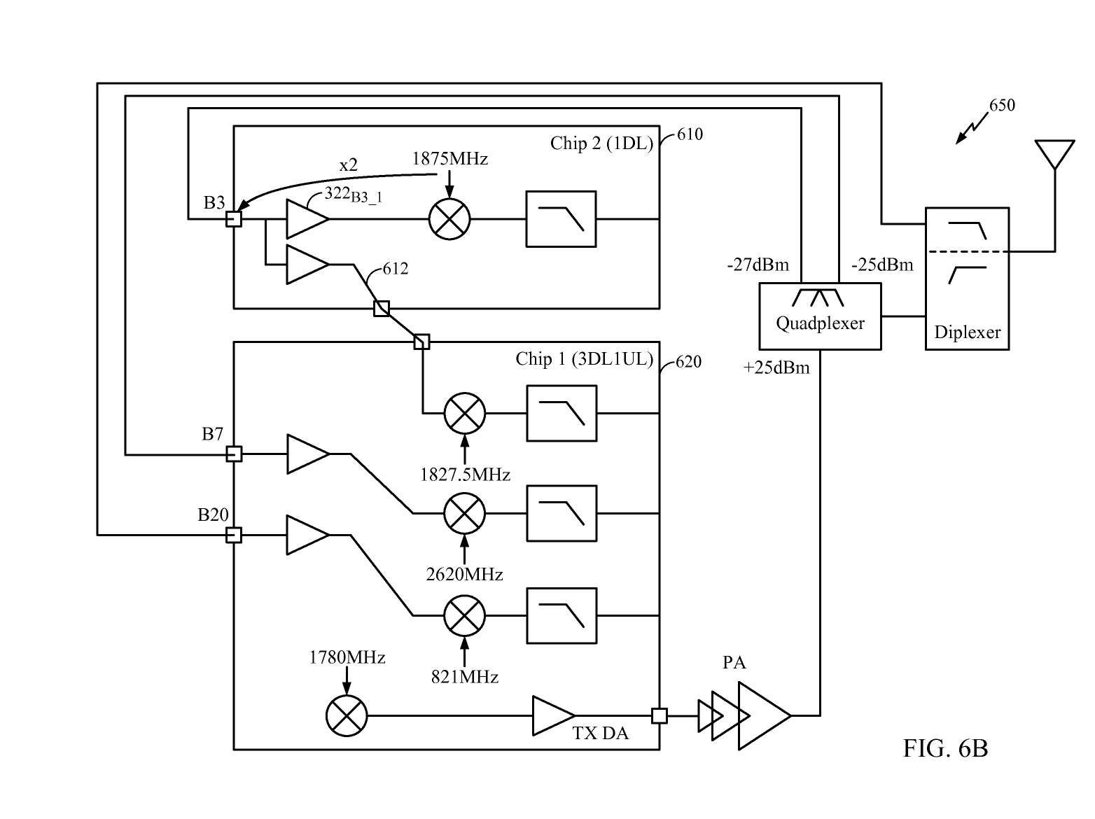

FIG. 6A illustrates an example block diagram 600 of an RX CA IC 610 for one DL channel and a TX/RX IC 620 for three DL channels and one UL channel (i.e., a 3DL1UL+1DL case), in accordance with certain aspects of the present disclosure. In this case, a component carrier of the PCELL (e.g., B3) is received by an LNA 322_{B3} on the RX CA IC 610, but is allocated to downconvert on the TX/RX IC 620. The PCELL is also allocated to upconvert on the same IC according to the duplex offset. This leads to the SCELL VCO frequency (which is twice the SCELL LO frequency, so 2*1827.5 MHz for B3 RX) coupling into the PCELL RX path at a node 612, where the difference between the SCELL VCO frequency and the PCELL TX frequency (1780 MHz for B3 TX) equals another PCELL RX component carrier (1875 MHz for B3 RX) and interferes with the performance of this component carrier's reception.

FIG. 6B illustrates an example block diagram 650 of the RX CA IC 610 and the TX/RX IC 620 of FIG. 6A, where the PCELL (e.g., B3) is allocated to downconvert on the RX CA IC 610 instead of on the TX/RX IC 620, in accordance with certain aspects of the present disclosure. For the example in FIG. 6B of B3+B3+B20+B7, the PCELL B3 downconversion may occur on the same IC as the LNA 322_{B3}_{_{—}}₁ (e.g., the RX CA IC 610).

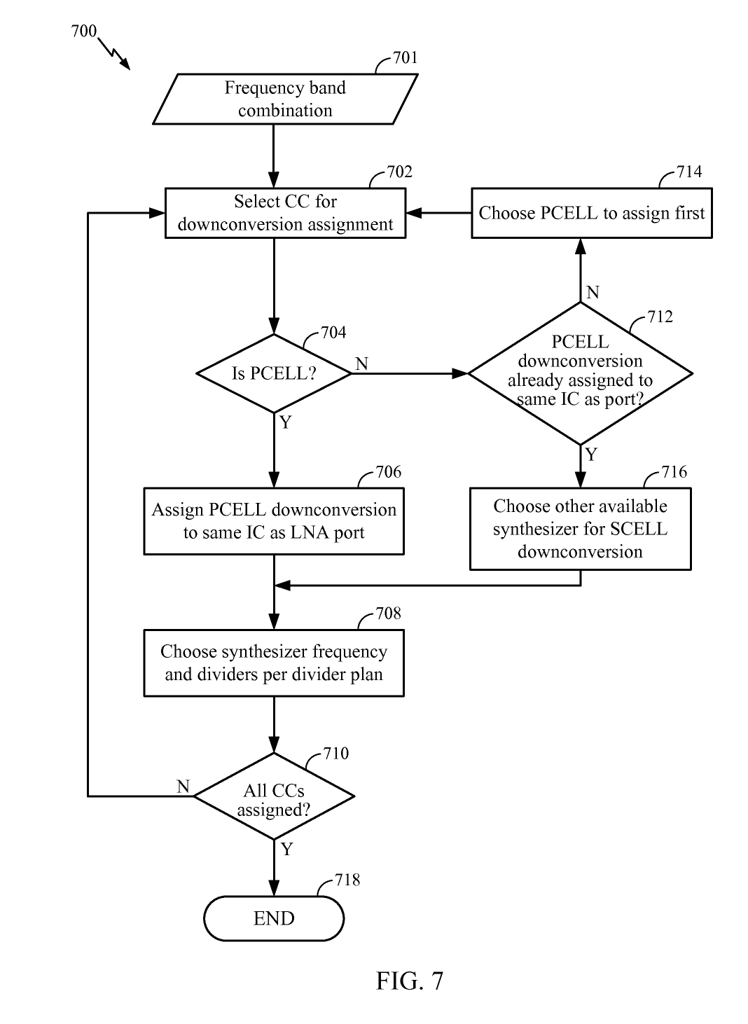

FIG. 7 is a flow diagram of example operations 700 for dynamic SCELL allocation, in accordance with certain aspects of the present disclosure. The operations 700 may be performed by a wireless designer or by a processing system.

The operations 700 may begin by selecting a downlink component carrier (CC) at 702 for downconversion assignment from a given frequency band combination 701. At 704, whether the selected component carrier is a PCELL is determined. If the selected component carrier is a PCELL, then at 706, the downlink PCELL is assigned for downconversion on the same IC as the LNA port receiving the PCELL. Then, the frequency synthesizer's frequency (e.g., the VCO frequency) and frequency divisor may be chosen at 708, based on a divider plan (as described below, for example). If all downlink component carriers have not been assigned as determined at 710, then a new component carrier may be selected at 702 for downconversion assignment.

If the new component carrier is not a PCELL as determined at 704, then whether the PCELL has already been allocated for downconversion on the same IC as the LNA port receiving the PCELL is determined at 712. If not, then the PCELL is chosen as the CC to be assigned first according to 714, and the operations 700 return to select another component carrier at 702. If the PCELL has already been allocated as determined at 712, then another available synthesizer is chosen for the SCELL downconversion at 716 (e.g., the component carrier is selected for a different receive path than that of the PCELL). The frequency synthesizer's frequency and frequency divisor for the SCELL downconversion are selected at 708, based on a divider plan (as described below). Once all the downlink component carriers have been assigned as determined at 710, then downlink assignment is complete at 718.

### Additional Frequency Dividing Options

Even when utilizing two separate ICs and the SCELL allocation described above, some problems may still remain. As a first example, in the B2+B4 scheme of FIG. 4B, the VCO frequency (which is twice the LO frequency) for the B2 RX (e.g., 2*1950 MHz) may mix with the B2 TX signal (e.g., 1750 MHz) due to TX second order intermodulation distortion (IM2) to produce a signal of 2*1950 MHz−1750 MHz=2150 MHz at the TX output. This spur in the RX band may go through the quadplexer 406, appear at the B4 RX input, and degrade sensitivity (i.e., cause “de-sense”). A second example is B4+B5 (where 6*2115 MHz−12*881 MHz=2118 MHz), or equivalently, 3*B4 RX VCO−3*B5 RX VCO=B4 RX. In this case the spur is enough to de-sense the system by 6 dB. The two VCOs are in two different ICs, but couple together anyway. A third example is B2+B17 (2*1855.1 MHz=5*742 MHz+0.2). In other words, B2 TX VCO couples on to the B17 LNA balun (e.g., used to convert the single-ended output of the LNA to a differential output for the mixer and other portions of the receive path) and is downconverted as a 5^{th} harmonic of the LO. Although problems for the second and third examples can be resolved by using digital notches in the digital baseband, there is a limitation on the number of notches due to memory, time, or throughput degradation.

Therefore, certain aspects of the present disclosure involve adding divider options to both the RX CA IC (e.g., WFR1620), as well as the TX/RX IC (e.g., WTR1625). For the RX CA IC, an option for dividing by 3 (div3) for B2/B4 is added, which will solve the first and second examples in the preceding paragraph. There may be other cases that involve addition of dividing by 6 (div6) for low frequency bands, as well, which may lead to the RX CA IC having divider options of div 2/3/4/6 for RX.

For the TX/RX IC, an option for div3 for B2 TX VCO is added in an effort to solve the third example described above. There may be other cases that will involve addition of div6 for low frequency bands, as well, which may lead to the TX/RX IC having divider options of div 2/3/4 for TX and possibly 2/3/4/6 for RX. As more band combinations are added, more dividers may be warranted.

Using additional divider options is significant for several reasons. For example, this solution involves a frequency plan for TX VCO, even though there may be only one TX channel for 2 RX CA channels. Also, there is a frequency plan for dividers, even with a multi-IC solution and a standard transceiver for one IC (or multiple ICs). Furthermore, with more channels added for the receiver, this will become critical to design, including when one IC is a standard transceiver as part of the multi-IC carrier aggregation solution.

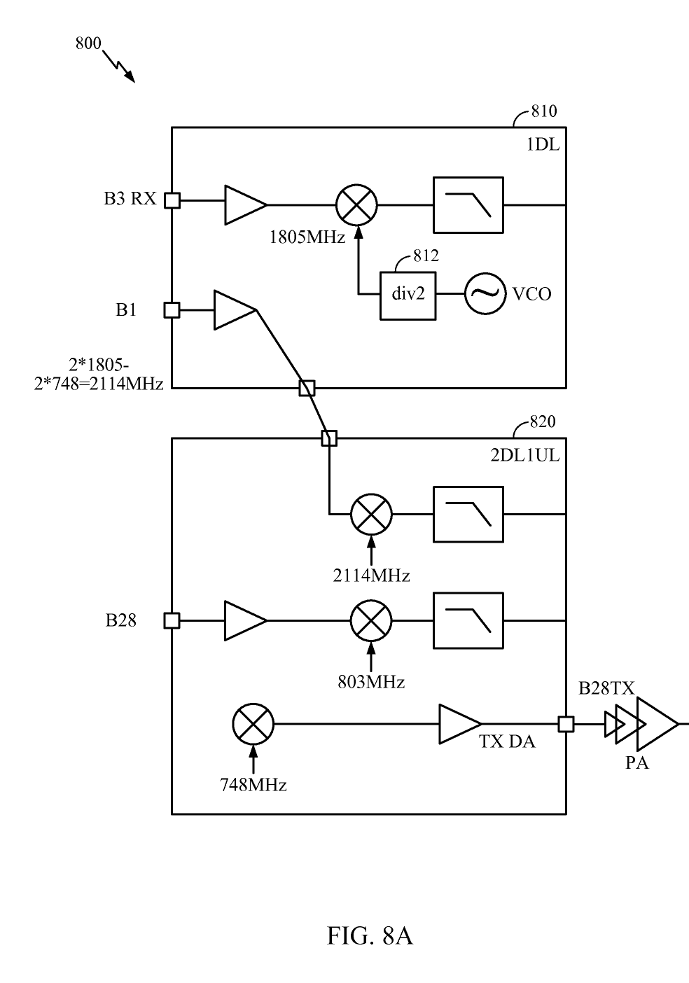

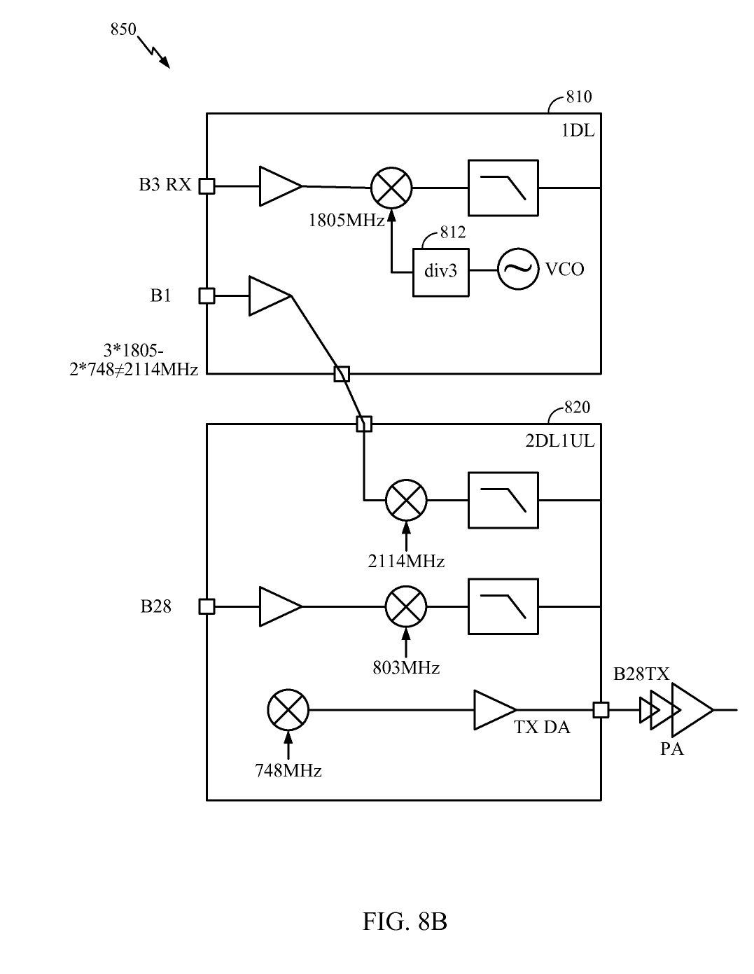

FIG. 8A illustrates an example block diagram 800 of an RX CA IC 810 for one DL channel and a TX/RX IC 820 for two DL channels and one UL channel (i.e., a 2DL1UL+1DL case), in accordance with certain aspects of the present disclosure. The TX/RX IC 820 may have all the divider ratios as determined by a 2DL1UL single-IC analysis. These may include div4/5/6 or div8/10/12 for low frequency bands being received, div2 or div3/4 for medium and high frequency bands being received, div2 for medium and high frequency bands being transmitted, and div3/4 for low frequency bands being transmitted. A 2DL1UL+1DL analysis may be performed to determine a frequency plan for the RX CA IC 810. For example, a B28+B1+B3 carrier aggregation scheme may be implemented, where the frequency dividing circuit 812 uses a div2 option. In this case, 2*B3 RX−2*B28 TX=B1 RX. However, this spur may be avoided by adding a divide-by-3 circuit for B3 RX on the RX CA IC 810, as illustrated in the example block diagram 850 of FIG. 8B, where the RX CA IC 810 employs a div3 option in the frequency dividing circuit 812 according to a designed frequency plan.

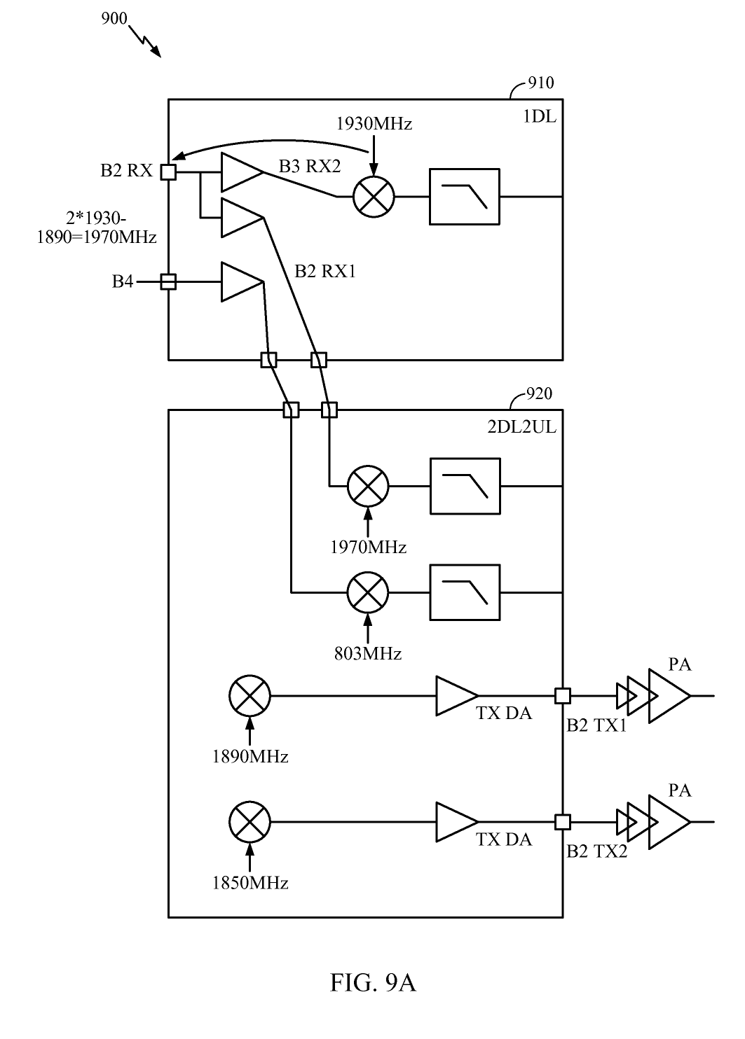

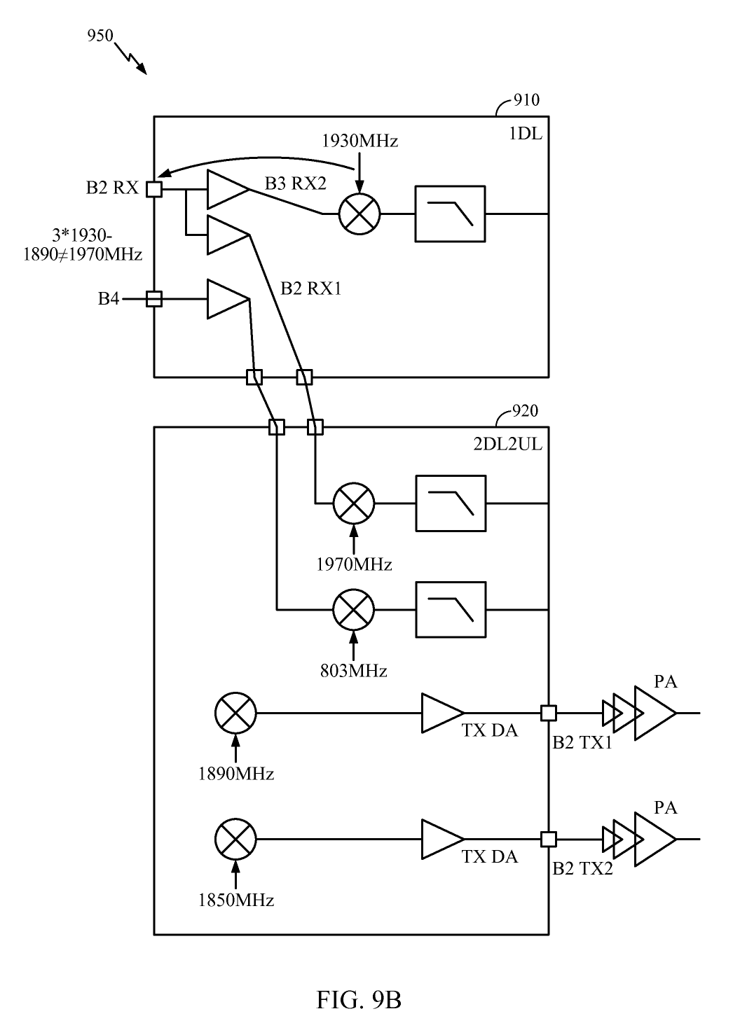

FIG. 9A illustrates an example block diagram 900 of an RX CA IC 910 for one DL channel and a TX/RX IC 920 for two DL channels and two UL channels (i.e., a 2DL2UL+1DL case), where the RX CA IC 910 employs a frequency dividing circuit according to a frequency plan analysis, in accordance with certain aspects of the present disclosure. For example, a B2+B2+B4 carrier aggregation scheme may be used. In this case, 2*B2 RX2−B2 TX1=B2 RX1 as shown in FIG. 9A. However, this spur may be avoided with a divide-by-3 for B2 RX2 on the RX CA IC 910. Therefore, based on this frequency plan analysis, the RX CA IC 910 in the example block diagram 950 of FIG. 9B employs a divide-by-3 frequency dividing circuit (e.g., a selectively configurable frequency dividing circuit capable of div3).

The various operations or methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

For example, means for transmitting may comprise a transmitter (e.g., the transceiver front end 254 of the user terminal 120 depicted in FIG. 2 or the transceiver front end 222 of the access point 110 shown in FIG. 2) and/or an antenna (e.g., the antennas 252ma through 252mu of the user terminal 120m portrayed in FIG. 2 or the antennas 224a through 224ap of the access point 110 illustrated in FIG. 2). Means for receiving may comprise a receiver (e.g., the transceiver front end 254 of the user terminal 120 depicted in FIG. 2 or the transceiver front end 222 of the access point 110 shown in FIG. 2) and/or an antenna (e.g., the antennas 252ma through 252mu of the user terminal 120m portrayed in FIG. 2 or the antennas 224a through 224ap of the access point 110 illustrated in FIG. 2). Means for processing or means for determining may comprise a processing system, which may include one or more processors, such as the RX data processor 270, the TX data processor 288, and/or the controller 280 of the user terminal 120 illustrated in FIG. 2.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A system for radio frequency (RF) signal processing, comprising:
a first integrated circuit (IC) comprising at least portions of two or more receive chains, each receive chain for processing one of multiple component carriers in a carrier aggregation (CA) signal, wherein the first IC is configured to downconvert a signal associated with a primary cell of the CA signal; and
a second IC configured to downconvert one or more signals associated with one or more secondary cells of the CA signal.

2. The system of claim 1, wherein the second IC is further configured to upconvert a transmit signal having a frequency different than the primary cell by an offset associated with the primary cell.

3. The system of claim 1, wherein the first IC comprises a CA receiver and wherein the second IC comprises a transceiver.

4. The system of claim 1, wherein the first IC comprises a first low noise amplifier (LNA) configured to amplify a signal associated with a first one of the secondary cells of the CA signal and wherein the second IC is configured to receive and to downconvert the amplified signal associated with the first one of the secondary cells.

5. The system of claim 4, wherein the first IC comprises a second LNA configured to amplify the signal associated with the primary cell of the CA signal and wherein the first IC is configured to downconvert the amplified signal associated with the primary cell.

6. The system of claim 4, wherein the first IC comprises a second LNA configured to amplify another signal associated with a second one of the secondary cells of the CA signal and wherein the second IC is configured to receive and to downconvert the other amplified signal associated with the second one of the secondary cells.

7. The system of claim 4, wherein the second IC comprises a second LNA configured to amplify another signal associated with a second one of the secondary cells of the CA signal and wherein the second IC is configured to downconvert the other amplified signal associated with the second one of the secondary cells.

8. The system of claim 1, wherein the primary cell is in Evolved UMTS (Universal Mobile Telecommunications System) Terrestrial Radio Access (E-UTRA) frequency band 4 (B4) and wherein at least one of the secondary cells is in E-UTRA frequency band 2 (B2).

9. The system of claim 1, wherein the first IC comprises a first voltage controlled oscillator (VCO) configured to generate a first local oscillating signal for mixing with the signal associated with the primary cell.

10. The system of claim 9, wherein the second IC comprises a second VCO configured to generate a second local oscillating signal for mixing with a signal associated with a secondary cell of the CA signal.

11. The system of claim 1, further comprising:
an antenna configured to receive the CA signal; and
at least one of a duplexer, a diplexer, a triplexer, or a quadplexer configured to filter the CA signal into the multiple component carriers for processing in the two or more receive chains.

12. The system of claim 11, further comprising a power amplifier, wherein the second IC is further configured to upconvert a transmit signal having a frequency different than the primary cell by an offset associated with the primary cell, wherein the power amplifier is configured to amplify the upconverted transmit signal, and wherein the amplified upconverted transmit signal is sent to the antenna via the at least one of the duplexer, the diplexer, the triplexer, or the quadplexer for wireless transmission.

13. The system of claim 1, wherein the first IC comprises a transceiver and wherein the second IC comprises a CA receiver.

14. A system for radio frequency (RF) signal processing, comprising:
a first integrated circuit (IC) comprising:
at least portions of two or more receive chains, each receive chain for processing one of multiple component carriers in a carrier aggregation (CA) signal;
a first voltage controlled oscillator (VCO) for producing a first VCO signal; and
a first frequency dividing circuit selectively configurable to frequency divide the first VCO signal by at least one of 2, 3, and 4 to generate a first local oscillating signal for downconverting a signal associated with a first component carrier of the CA signal; and
a second IC comprising:
a second VCO for producing a second VCO signal;
a second frequency dividing circuit selectively configurable to frequency divide the second VCO signal by at least one of 2 and 4 to generate a second local oscillating signal for downconverting a signal associated with a second component carrier of the CA signal;
a third VCO for producing a third VCO signal; and
a third frequency dividing circuit selectively configurable to frequency divide the third VCO signal by at least one of 2, 3, and 4 to generate a third local oscillating signal for upconverting a transmit signal having a frequency different than a first one of the multiple component carriers by an offset associated with the first one of the multiple component carriers.

15. The system of claim 14, wherein the first IC comprises a CA receiver.

16. The system of claim 14, wherein the second IC comprises a transceiver.

17. The system of claim 14, wherein the second frequency dividing circuit is selectively configurable to frequency divide the second VCO signal by 2, by 3, and by 4.

18. The system of claim 14, wherein at least one of the first or the second frequency dividing circuit is selectively configurable to frequency divide the first or the second VCO signal, respectively, by 2, by 3, by 4, and by 6.

19. The system of claim 14, wherein the first IC comprises a first low noise amplifier (LNA) configured to amplify a second one of the multiple component carriers to generate the signal associated with the second component carrier of the CA signal and wherein the second IC is configured to receive the signal associated with the second component carrier from the first IC before downconverting.

20. The system of claim 19, wherein the first IC comprises a second LNA configured to amplify a third one of the multiple component carriers to generate the signal associated with the first component carrier of the CA signal before downconverting.

21. The system of claim 20, wherein the third one of the multiple component carriers is the first one of the multiple component carriers.

22. The system of claim 19, wherein the first IC comprises a second LNA configured to amplify a third one of the multiple component carriers and wherein the second IC is configured to receive and to downconvert the amplified third one of the multiple component carriers.

23. The system of claim 19, wherein the second IC comprises a second LNA configured to amplify a third one of the multiple component carriers and wherein the second IC is configured to downconvert the amplified third one of the multiple component carriers.

24. The system of claim 14, further comprising:
an antenna configured to receive the CA signal; and
at least one of a duplexer, a diplexer, a triplexer, or a quadplexer configured to filter the CA signal into the multiple component carriers for processing in the two or more receive chains.

25. The system of claim 24, further comprising a power amplifier for amplifying the upconverted signal, wherein the amplified upconverted signal is sent to the antenna via the at least one of the duplexer, the diplexer, the triplexer, or the quadplexer for wireless transmission.

26. The system of claim 14, wherein the first one of the multiple component carriers is the first component carrier of the CA signal.
